(19) United States
(12) Patent Application Publication
(10) Pub. No.: US 2023/0414451 A1
(43) Pub. Date: Dec. 28, 2023

(54) PLASTIC ADAPTER AND CLOSED SYSTEM DRUG TRANSFER DEVICE

(71) Applicant: DAIKYO SEIKO, LTD., Sano-shi (JP)

(72) Inventor: Takayuki YOSHIDA, Sano-shi (JP)

(73) Assignee: DAIKYO SEIKO, LTD., Sano-shi (JP)

(21) Appl. No.: 18/254,814

(22) PCT Filed: Dec. 25, 2020
(86) PCT No.: PCT/JP2020/048649

§ 371 Date: May 26, 2023

(51) Int. Cl. A61J 1/20; A61J 1/14

(52) U.S. Cl. CPC A61J 1/201; A61J 1/1468; A61J 1/1406; A61J 1/2048

(57) ABSTRACT

To provide a plastic adapter that includes a plastic cap and can be safely applied to the closed system drug transfer device.

Provided is a plastic adapter attached to a pharmaceutical container to which a plastic cap is attached, and the adapter includes a top surface portion having a fitting portion at the center thereof, and a cylindrical skirt portion extending downward from an outer periphery of the top surface portion and opening at a lower end, in which the fitting portion includes a lip and an intermediate tube extending downward from the lip, and the fitting portion fits to a medical instrument used for a closed system drug transfer device.

### TECHNICAL FIELD

The present invention relates to a plastic adapter and a closed system drug transfer device. More specifically, the present invention relates to a plastic adapter that includes a plastic cap and can be safely applied to the closed system drug transfer device, and a closed system drug transfer device using the adapter.

### BACKGROUND ART

Pharmaceutical containers such as a vial are widely used as storage containers for various drugs including pharmaceutical products in related art. The pharmaceutical container is used in a state where, after the drug is stored, a mouth portion of the pharmaceutical container is sealed with a rubber stopper to make the interior of the pharmaceutical container hermetically sealed. The drug stored in the pharmaceutical container is transferred by a user such as a healthcare worker by using, for example, a liquid drug transfer device described in Patent Literature 1, a telescopic female drug vial adapter described in Patent Literature 2, and the like. When the drug stored in the pharmaceutical container is particularly an anticancer drug, it is necessary to use, in general, a closed system drug transfer device (CSTD) for preventing exposure to the user due to the leakage or the like of aerosol, vapor, and liquid from the interior of the pharmaceutical container.

### CITATION LIST

### Patent Literature

PTL 1: JP2009-504230A

PTL 2: JP2015-528368A

### SUMMARY OF INVENTION

### Technical Problem

When the above-described drug transfer device or the like does not match with the pharmaceutical container, it becomes difficult to puncture the rubber stopper of the pharmaceutical container, and there is a danger of causing an accident such as the leakage of the drug from the pharmaceutical container in some cases.

Moreover, in the above-described telescopic female drug vial adapter, the drug vial adapter matches with a drug vial in a lower portion of the adapter. An upper portion of the adapter has a standing female connector for joining to a needleless syringe. Therefore, it is necessary that, not only the drug vial side in the lower portion of the adapter but also the upper portion of the adapter is fitted to a medical instrument used for the closed system drug transfer device, and thus there is a problem that a plurality of connection adapters are required.

In the pharmaceutical vial described in Patent Literature 1 and Patent Literature 2, an aluminum cap called a band is attached at a vial opening. Here, the aluminum cap is mainly used in related art; however, the use of a plastic cap with different shapes and sizes in various manufacturers is increasing, and there is also a problem that there is no vial adapter which can contain the plastic cap.

In view of the above, the present invention provides a plastic adapter that can prevent the leakage of the drug by being safely applied to the closed system drug transfer device and can contain and lock the plastic cap without requiring a plurality of connection adapters.

### Solution to Problem

That is, the present invention provides a plastic adapter (E) attached to a pharmaceutical container (A) to which a plastic cap is attached,

the adapter (E) includes a top surface portion (E1) having a fitting portion (E11) at the center thereof, and a cylindrical skirt portion (E2) extending downward from an outer periphery of the top surface portion (E1) and opening at a lower end,

in which the fitting portion (E11) includes a lip (E112) and an intermediate tube (E113) extending downward from the lip (E112), and

the fitting portion (E11) fits to a medical instrument (F) used for a closed system drug transfer device.

The plastic adapter according to the present invention may further include a puncturing portion (E3) extending downward from the center of a lower surface of the top surface portion (E1) and communicating with the interior of the pharmaceutical container (A) inside the skirt portion (E2).

In the present invention, the lip (E112) may include an upper surface (E115), a rubber stopper (E11), and a lower surface (E114), and at least one place in the upper surface (E115) or the lower surface (E114) may contact the medical instrument (F).

In the present invention, at least one or more locking claws (E21) engaging with a lower portion of a lip (A2) of the pharmaceutical container (A) may be formed on an inner surface at a lower end of the skirt portion (E2).

In the present invention, at least one or more cutout portions (E22) may be provided in a height direction on an outer peripheral surface of the skirt portion (E2).

In the present invention, a cover (D) which is removable by fingers may be provided on an upper surface of the fitting portion (E11).

According to the present invention, there is also provided a closed system drug transfer device including

a plastic cap (C) attached to a pharmaceutical container (A), which has a top surface portion (C1) having an opening (C10) at the center thereof, a cylindrical skirt portion (C2) extending downward from an outer periphery of the top surface portion (C1) and opening at a lower end, and an inner cover (C3) provided inside the skirt portion (C2), in which a coefficient of friction between the inner cover (C3) and a rubber stopper (B) is higher than a coefficient of friction between the inner cover (C3) and the cap (C), and

a plastic adapter (E) attached to the plastic cap (C), which has a top surface portion (E1) having a fitting portion (E11) at the center thereof, and a cylindrical skirt portion (E2) extending downward from an outer periphery of the top surface portion (E1) and opening at a lower end, in which the fitting portion (E11) has a lip (E112) and an intermediate tube (E113) extending downward from the lip (E112), and the fitting portion (E11) fits to a medical instrument (F) used for the closed system drug transfer device.

### ADVANTAGEOUS EFFECTS OF INVENTION

According to the present invention, a plastic adapter that includes a plastic cap and can be safely applied to the closed system drug transfer device can be provided.

Note that the effects described here are not always limited to the above, and may be some of effects described in the specification.

### BRIEF DESCRIPTION OF DRAWINGS

FIG. 1 is a view illustrating an example of an embodiment of an adapter E according to the present invention.

FIG. 2 is a view illustrating an example of the embodiment of the adapter E according to the prevent invention, which is applied to a pharmaceutical container A.

FIG. 3 is a perspective view of an example of the embodiment of the adapter E according to the present invention, which is seen from above.

FIG. 4 is a perspective view of an example of the embodiment of the adapter E according to the present invention, which is seen from the bottom.

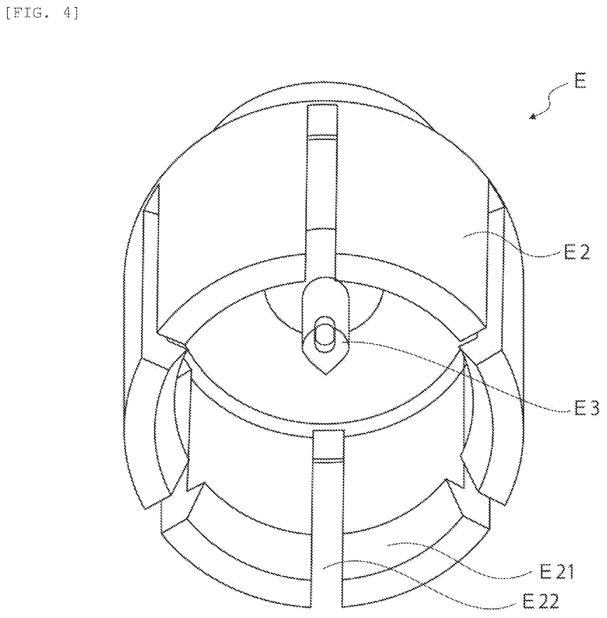

FIG. 5 is a view illustrating an example of the embodiment of the adapter E according to the present invention.

### DESCRIPTION OF EMBODIMENTS

Hereinafter, preferred embodiments of the present invention will be explained.

Embodiments described below are examples of a representative embodiment of the present invention, and the scope of the present invention should not be narrowly interpreted based on these examples.

### 1: Plastic Adapter E

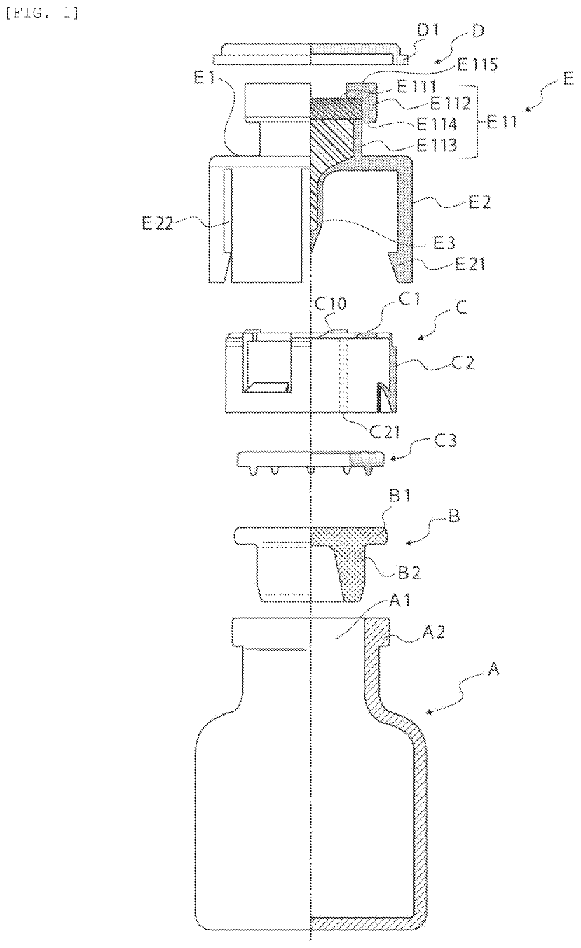

FIG. 1 is a view illustrating an example of an embodiment of an adapter E according to the present invention.

The plastic adapter E according to the present invention is an adapter used by covering a rubber stopper B which seals an opening Al of a pharmaceutical container A and being fitted to the pharmaceutical container A, for example, through a later-described plastic cap C or a common vial adapter, which can be applied to a CSTD.

Here, the definition of the CSTD will bge explained. The closed system drug transfer device may indicate two items which are a closed system connection instrument (not illustrated) and a closed system dosing route; however, the former closed system connection instrument is mainly indicated in the present description.

The adapter E includes a top surface portion E1 having a fitting portion E11 at the center thereof, and a cylindrical skirt portion E2 extending downward from an outer periphery of the top surface portion E1 and opening at a lower end. The fitting portion E11 has a lip E112 and an intermediate tube E113 extending downward from the lip E112, and the fitting portion E11 fits to a medical instrument F which is a closed system connection instrument. An outer diameter of the skirt portion E2 is preferably larger than a diameter of the intermediate tube E113.

Note that, for example, a vial adapter having a common needle portion is indicated as the medical instrument F. The adapter E according to the present invention which has the above structure can maintain aseptic properties inside the pharmaceutical container A while preventing exposure due to the leakage or the like of aerosol, vapor, and liquid from the interior of the pharmaceutical container A, and can be safely applied to the closed system drug transfer device when the later-described plastic cap C and the adapter E according to the present invention are used.

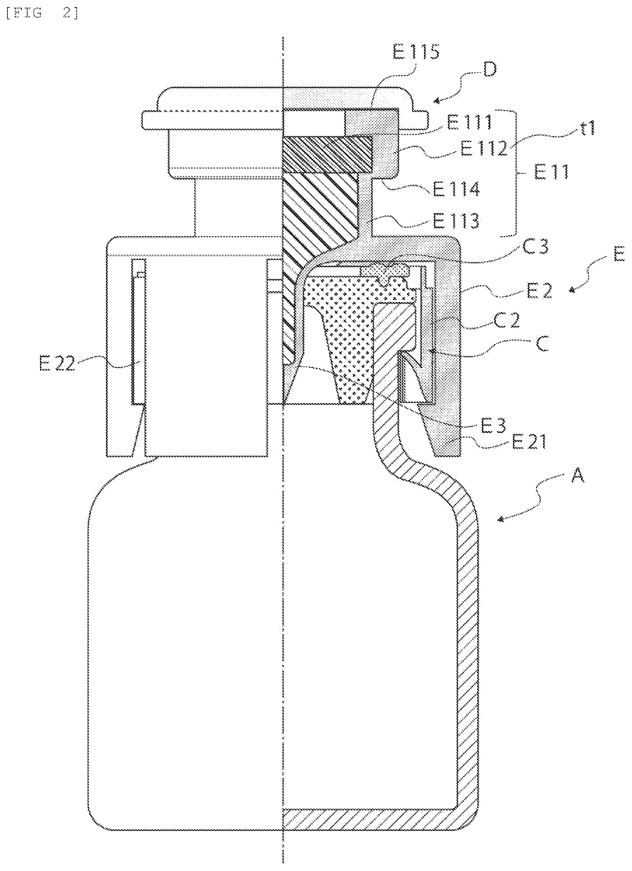

In the preferred embodiment of the present invention, the adapter E attached so as to cover the plastic cap C further includes a puncturing portion E3 extending downward from the center of a lower surface of the top surface portion E1 and communicating with the interior of the pharmaceutical container A inside the skirt portion E2 as illustrated in FIG. 1 and FIG. 2. When the puncturing portion E3 is provided, it is possible to puncture the rubber stopper B even when a puncturing instrument or the like is not separately used; therefore, complexity at the time of use can be avoided.

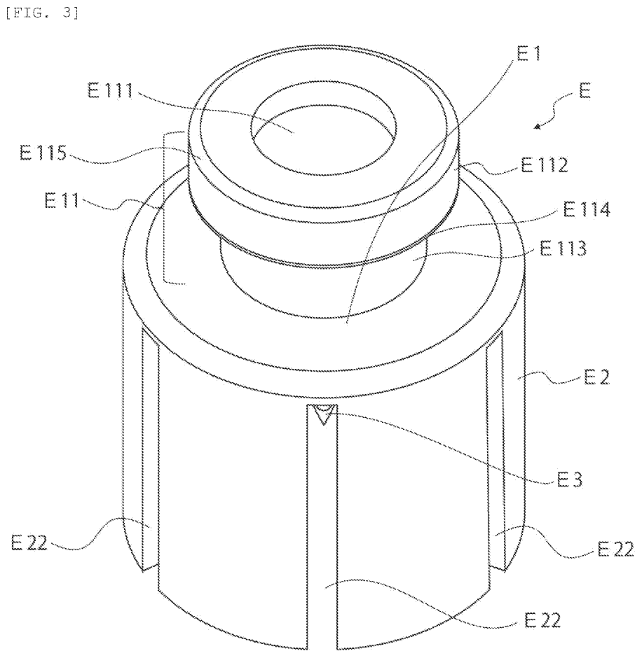

As illustrated in FIG. 1 and FIG. 3, the adapter E according to the present invention includes the top surface portion E1 having the approximately T-shaped fitting portion E11 at the center thereof, and the cylindrical skirt portion E2 extending downward from an outer periphery of the top surface portion E1 and opening at a lower end, in which the fitting portion E11 includes the lip E112 and the intermediate tube E113 extending downward from the lip E112. The lip E112 has an upper surface E115 and a lower surface E114, and a disc-shaped rubber stopper E111 for preventing exposure of a drug is provided inside the lip E112.

As illustrated in FIG. 2, a height t1 forming the lip E112 in the fitting portion E11 of the adapter E according to the present invention can be changed suitably and freely in consideration of an inner surface depth (length) on the side where a needle of the medical instrument F (not illustrated) which is a closed system connection instrument to be fitted is provided and a thickness of the rubber stopper E111 provided in the fitting portion E11.

Moreover, at least one or more locking claws E21 engaging with the plastic cap C so as to cover the plastic cap C from an outer side are formed on an inner surface at the lower end of the skirt portion E2.

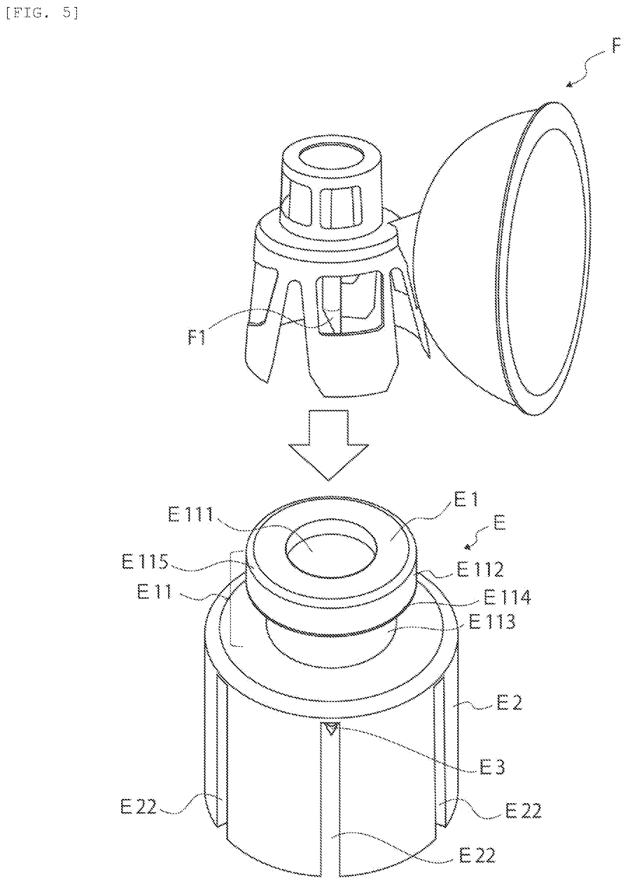

Next, how the fitting portion E11 of the adapter E according to the present invention is fitted will be described with reference to FIG. 5.

When the fitting portion E11 of the adapter E according to the present invention is fitted, there is a case where the vial adapter which is the medical instrument F includes a housing and a case where the vial adapter which is the medical instrument F does not include a housing. In FIG. 5, the former case of including the housing is illustrated.

When the vial adapter as the medical instrument F has the housing, the vial adapter as the medical instrument F provided with a spike needle F1 fits to the fitting portion E11 of the adapter E from an upper surface and contacts two places on the upper surface E115 and the lower surface E114 that form an outer edge portion of the lip E112 inside the housing to be fitted there. Consequently, the medical instrument F and the adapter E according to the present invention can be firmly fixed.

When the vial adapter as the medical instrument F does not have the housing, a flange portion (not illustrated) forming a root of the spike needle F1 contacts at least one place on the upper surface E115 of the lip E112. In this case, the spike needle F1 can be stuck to a drug through the disc-shaped rubber stopper E111 provided in the lip E112; therefore, exposure due to the leakage or the like of liquid can be prevented, and safer application to the closed system drug transfer device can be realized.

In the preferred embodiment of the present invention, at least one or more locking claws E21 engaging with the plastic cap C so as to cover the plastic cap C from the outer side are formed on an inner side of the lower end of the skirt portion E2 of the adapter E as illustrated in FIG. 1 and FIG. 2. The number of the locking claw E21 is not particularly limited; but a plurality of locking claws E21 are preferably formed. Moreover, the locking claw E21 may be formed to have a reverse-L shape, and for example, formed into a convex shape horizontally extending in an inner diameter direction. According to the above, even when a force toward an upper direction is added to the adapter E, it is possible to prevent the adapter E from easily coming off. Furthermore, a cutout portion E22 as a gap closely contacting the locking claw E21 and provided in perpendicular to the skirt portion E2 can be used also as a positioning mechanism for visually recognizing a fitting position to the pharmaceutical container A at the time of fitting to the later-described cap C.

In the preferred embodiment of the present invention, at least one or more cutout portions E22 are provided in a height direction on an outer peripheral surface of the skirt portion E2 as illustrated in FIG. 3. The number of cutout portions E22 is not particularly limited; however, a plurality of cutout portions E22 are preferably formed. Accordingly, it is possible to improve flexibility of the skirt portion E2 and to prevent the occurrence of damage such as a crack at the time of fitting the adapter E.

In the rubber stopper B illustrated in FIG. 1 in the present invention, a plastic film is laminated on a leg portion B2 of the rubber stopper B from a viewpoint of slipperiness and for preventing the docking, that is, sticking of rubber stoppers to each other.

In addition, it is preferable that a lower portion of a canopy portion B1 is a rubber base surface, and further, it is preferable that a root of the leg portion B2 of the rubber stopper B is also the rubber base surface in order to secure higher hermeticity than that of the rubber stopper B illustrated in FIG. 1.

Furthermore, a top surface of the canopy portion B1 of the rubber stopper B to which a lubricant such as silicone is not applied is preferably used in the same manner as the leg portion B2 of the rubber stopper B. That is because protein aggregation occurs when the lubricant such as silicone is applied. When slipperiness is necessary on the top surface of the canopy portion B1 of the rubber stopper B, the plastic film may simply need to be laminated. General plastic films such as films of polyethylene, polypropylene, and fluorine-based resin can be used as the plastic film used for the rubber stopper B.

A material for forming the adapter E according to the present invention is preferably a resin excellent in heat resistance, slipperiness, sterilization resistance, and strength, which includes a thermoplastic resin, a thermoplastic elastomer (TPE), and a polyolefin-based resign; however, the material is not limited to the above, and can be selected suitably and freely. Specifically, for example, a fluorine-based resin, a polyethylene-based resin, a polypropylene-based resin (PP, including not only a homopolymer but also a copolymer obtained by copolymerizing an ethylene group, a butylene group or the like), a polyester-based resin (PET), a polysulfone-based resin (PSF), a methyl pentene-based resin (PMP), a polyacrylate-based resin (PAR), a polyamide-based resin (PA), a modified polyphenylene oxide resin (m-PPE), a resin containing a cyclic olefin-based compound or a bridged polycyclic hydrocarbon compound as a polymer component, a polycarbonate resin (PC), a resin obtained by modifying (grafting) an olefin-based resin using a polar group, polyacetal (POM) that is excellent also in wear resistance and the like can be cited; however, the materials are not limited to the above as long as the material does not have a problem in conditions for autoclave sterilization, which are, for example, heat resistance for withstanding 121° C. for 20 minutes, or a problem in strength such as deterioration and a crack, and the material can be sterilized by radiation sterilization and the like. When the adapter E according to the present invention is formed of plastic, fine particles and the like are not generated even when the adapter E rubs against or collided with the medical instrument F which is the closed system connection instrument. Additionally, the adapter E can be manufactured by, for example, injection molding; therefore, the degree of freedom in shape and structure is high.

In the adapter E according to the present invention, a cover D which is removable by fingers is integrally provided on the upper surface of the fitting portion Ell as illustrated in FIG. 1 and FIG. 2. That is, it is preferable that the adapter E and the cover D are respectively molded and welded by, for example, the above-described resin. It is naturally possible to integrally mold the adapter E and the cover D by various types of methods. Although the cover D is not essential in the present invention, the cover D is preferably provided for preventing contamination on the upper surface of the fitting portion E11. It is preferable that the cover D is provided with one or a plurality of finger hooks D1 formed over the entire circumference or partially formed. A user can put a finger on the finger hook D1 to remove the cover D easily according to need.

As other embodiments of the cover D, formation by a gas impermeable film which is impermeable to gas, water vapor, germs, and the like, or a gas permeable film which is permeable to gas, water vapor, and the like can be cited. It is preferable to apply a method whereby contamination of the rubber stopper E111 provided inside the fitting portion E11 can be prevented. For example, the cover D may be formed by a seal or the like which can cover the upper surface E115 of the fitting portion E11 of the adapter E according to the invention and can be removable therefrom.

A method for using the adapter E according to the present invention described above will be explained with reference to FIG. 1.

First, after the pharmaceutical container A is filled with a desired drug, the rubber stopper B with a suitable size is fitted into the opening A1 of the pharmaceutical container A to seal the pharmaceutical container A. The pharmaceutical container A that stores the drug is applied to the CSTD by a user such as a healthcare worker. At this time, the adapter E is fitted into the pharmaceutical container A in a sealed state with the rubber stopper B through the later-described plastic cap C for preventing exposure due to the leakage or the like of aerosol, vapor, and liquid from the interior of the pharmaceutical container A. According to the above, the locking claw E21 with the reverse-L shape provided on the inner surface of the adapter E is elastically deformed and moves downward while abutting on an outer peripheral surface of a skirt portion C2 of the cap C as the adapter E moves downward, and when a tip end of the locking claw E21 passes the outer peripheral surface of the skirt portion C2 of the cap C, the locking claw E21 returns to an original state to fix the adapter E. Subsequently, the user fits the medical instrument F used for the CSTD to the adapter E from an upper lid side of the fitting portion E11 and transfers the drug.

In the above described example, after the rubber stopper B is fitted to the opening A1 of the pharmaceutical container A so as to make the pharmaceutical container A hermetically sealed, the adapter E is fitted through the later-described plastic cap C; however, the present invention is not limited to this.

### 2. Closed System Drug Transfer Device

The present invention also provides a closed system drug transfer device using the later-described plastic cap C and the above-described adapter E according to the present invention. As described above, the adapter E can be applied to the CSTD through the cap C. Since the adapter E is as described above, description therefor is omitted here.

The plastic cap C is a cap for preventing coming-off of the rubber stopper B that seals the opening A1 of the pharmaceutical container A as illustrated in FIG. 1. The cap C includes a top surface portion C1 having an opening C10 at the center thereof, a cylindrical skirt portion C2 extending downward from an outer periphery of the top surface portion C1 and opening at a lower end, and an inner cover C3 provided inside the skirt portion. Moreover, a coefficient of friction between the inner cover C3 and a rubber stopper B is higher than a coefficient of friction between the inner cover C3 and the cap C. Therefore, even when a force in a lateral direction is added to the cap C in a state where the cap C is applied and fitted to the capped rubber stopper B, the cap C only rotates in an idling fashion, and the rubber stopper B does not rotate. Consequently, the airtightness of the rubber stopper B can be maintained.

In the preferred embodiment of the present invention, the cap C has at least one or more slit portions C21 in the skirt portion C2 as illustrated in FIG. 1. A plurality of slit portions C21 are preferably formed, which are formed, for example, at three places. The slit portions C21 can be used as a positioning mechanism used when the cap C is fitted to the adapter E according to the present invention. As the positioning mechanism for the adapter E, for example, a method for providing a convex-shaped member (not illustrated) on an inner wall of the skirt portion C2 and the like can be cited.

The top surface portion C1 of the cap C has a disc shape, and the opening C10 is formed at the central portion thereof. The size of the opening C10 is not particularly limited as long as effects of the present invention can be obtained. In the closed system drug transfer device according to the present invention, the puncturing portion E3 fits to the center of the opening C10 and punctures the rubber stopper B held inside the cap C.

A method for using the closed system drug transfer device according to the present invention described above will be explained with reference to FIG. 1.

First, after the pharmaceutical container A is filled with a desired drug, the rubber stopper B with a suitable size is fitted into the opening A1 of the pharmaceutical container A to seal the pharmaceutical container A. Subsequently, when the cap C is fitted to the pharmaceutical container A which is sealed with the rubber stopper B by preferably using the capping machine, the rubber stopper B and the cap C are fixed to each other. The pharmaceutical containerA storing a drug is used for the CSTD by a user such as a healthcare worker. The adapter E is fitted to the cap C so as to cover the cap C while performing positioning by the slit portions C21, thereby fixing the cap C and the adapter E to each other. Subsequently, the user punctures the rubber stopper E111 from the upper surface E115 side by using the medical instrument F used for the CSTD and transfers the drug.

In the above described example, after the rubber stopper B is fitted to the opening A1 of the pharmaceutical container A so as to make the pharmaceutical container A hermetically sealed, the cap C is fitted to the rubber stopper B, and further, the adapter E is fitted to the cap C; however, the present invention is not limited to this.

The adapter E according to the present invention contains the plastic cap C in the skirt portion E2 and can be locked by the locking claws E21 provided in the skirt portion E2, which can be safely applied to the closed system drug transfer device and can prevent the leakage of the drug. In addition, the height t1 forming the lip E112 in the fitting portion E11 of the adapter E according to the present invention can be changed suitably and freely in consideration of an inner surface depth (length) on the side where a needle of the medical instrument F (not illustrated) which is a closed system connection instrument to be fitted is provided and a thickness of the rubber stopper E111 provided in the fitting portion E11; therefore, the adapter E can be applied alone to various closed system connection instruments, and a plurality of connection adapters are not necessary.

### INDUSTRIAL APPLICABILITY

As apparent from the above, according to the present invention, it is possible to provide a plastic adapter that can maintain aseptic properties inside the pharmaceutical container A while preventing exposure due to the leakage or the like of aerosol, vapor, and liquid from the interior of the pharmaceutical container and can be safely applied to the closed system drug transfer device, and further, that can contain and lock the plastic cap without requiring the plural connection adapters.

### REFERENCE SIGNS LIST

A: pharmaceutical container
A1: opening
A2: lip
B: rubber stopper
B1: canopy portion
B2: leg portion
C: plastic cap
C1: top surface portion
C2: skirt portion
C21: slit portions
C3: inner cover
C10: opening
D: cover
D1: finger hook
E: plastic adapter
E1: top surface portion
E11: fitting portion
E111: rubber stopper
E112: lip
E113: intermediate tube
E114: lower surface
E115: upper surface
E2: skirt portion
E21: locking claw
E22: cutout portion
E3: puncturing portion
F: medical instrument
F1: spike needle

1. A plastic adapter (E) attached to a pharmaceutical container (A) to which a plastic cap is attached, the adapter (E) comprising:
a top surface portion (E1) having a fitting portion (E11) at the center thereof; and
a cylindrical skirt portion (E2) extending downward from an outer periphery of the top surface portion (E1) and opening at a lower end,
wherein the fitting portion (E11) includes a lip (E112) aand an intermediate tube (E113) extending downward from the lip (E112), and
the fitting portion (E11) fits to a medical instrument (F) used for a closed system drug transfer device.

2. The plastic adapter according to claim 1, further comprising:
a puncturing portion (E3) extending downward from the center of a lower surface of the top surface portion (E1) and communicating with the interior of the pharmaceutical container (A) inside the skirt portion (E2).

3. The plastic adapter according to claim 1,
wherein the lip (E112) includes an upper surface (E115), a rubber stopper (E111), and a lower surface (E114), and
at least one place in the upper surface (E115) or the lower surface (E114) contacts the medical instrument (F).

4. The plastic adapter according to claim 1,
wherein at least one or more locking claws (E21) engaging with a lower portion of a lip (A2) of the pharmaceutical container (A) are formed on an inner surface at a lower end of the skirt portion (E2).

5. The plastic adapter according to claim 1,
wherein at least one or more cutout portions (E22) are provided in a height direction on an outer peripheral surface of the skirt portion (E2).

6. The plastic adapter according to claim 1,
wherein a cover (D) which is removable by fingers is provided on an upper surface of the fitting portion (E11).

7. A closed system drug transfer device comprising:
a plastic cap (C) attached to a pharmaceutical container (A), which includes a top surface portion (C1) having an opening (C10) at the center thereof, a cylindrical skirt portion (C2) extending downward from an outer periphery of the top surface portion (C1) and opening at a lower end, and an inner cover (C3) provided inside the skirt portion (C2), in which a coefficient of friction between the inner cover (C3) and a rubber stopper (B) is higher than a coefficient of friction between the inner cover (C3) and the cap (C); and
a plastic adapter (E) attached to the plastic cap (C), which includes a top surface portion (E1) having a fitting portion (E11) at the center thereof, and a cylindrical skirt portion (E2) extending downward from an outer periphery of the top surface portion (E1) and opening at a lower end, in which the fitting portion (E11) has a lip (E112) and an intermediate tube (E113) extending downward from the lip (E112), and the fitting portion (E11) fits to a medical instrument (F) used for the closed system drug transfer device.
